(19) United States
(12) Patent Application Publication
(10) Pub. No.: US 2005/0278755 A1
(43) Pub. Date: Dec. 15, 2005

(54) Video data processing system with integrated high speed connection capacity

(75) Inventors: Jonathan H. Kuo, Aliso Viejo, CA (US); Khanh T. Vu, Irvine, CA (US); Tony Turner, Foothill Ranch, CA (US); Joseph Fiorenza JR., Ladera Ranch, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA (US)

(21) Appl. No.: 10/863,334

(22) Filed: Jun. 9, 2004

(51) Int. Cl. H04N 7/173; H04N 11/00; H04N 7/16

(52) U.S. Cl. 725/80; 725/100; 725/131; 725/133; 725/153; 348/552

(57) ABSTRACT

A video data processing device, such as a set-top box for satellite, DSL, or cable video and data services, has a USB 2.0 interface to support connections to local devices and networks. The interface is supported by drivers that provide data connectivity with the internal system bus of the data processing device, to support wired and/or wireless home networking with computers and other set-top boxes, data storage and retrieval on hard drives and other storage media, and other data transfer operations to support digital cameras, game ports, and printers.

### BACKGROUND OF THE INVENTION

1. Field of the Invention

The present invention relates to a video data processing device with improved networking and device connection capacity provided through a high speed data interface.

2. Background Art

Broadband video and data services are offered to homes and businesses via cable, satellite, telephone, microwave, and other transmission methods. Current broadband offerings through telephone systems include digital subscriber line (DSL) service and its variations such as asynchronous DSL (ADSL), as well as digital data services offered by wireless telephone companies.

Typically a data processing device is provided as an interface between the broadband transmission medium and televisions or computing devices that are connected to the broadband service. The data processing device used as an interface in video service applications often takes the form of a small box suitable for placement on or near a television or video monitor. The box has a connection for the broadband network (satellite, cable, telephone or other networks) and a connection for the video or other data output. A device of this type is often referred to as a “set-top box.”

Many set-top boxes, particularly those designed to provide video services, incorporate a modulator and provide a standard analog television video output generated from the received digital broadband data signals.

There has been substantial convergence between video and computer devices. Personal computers continue to become more powerful and less expensive, and current models of personal computers have video processing circuits and central processor capacity sufficient to receive streaming digital video and audio data and function like a television to display the video and audio data. Many personal computers now include a drive that will read digital video disks. Some personal computers are also equipped with analog video processing capability, allowing such computers to obtain digital or analog data from disks or broadband network connections, and generate analog television signals that can be displayed on televisions and video monitors. Thus, personal computers can now perform many of the functions traditionally performed by a television.

Similarly, much of the processing in televisions and television-related devices, such as set-top boxes, digital video recorders, and DVD players, is performed digitally, and such devices have integrated digital computers that control their operation and perform video data processing and display functions.

Video-oriented set-top boxes may be connected to, and in some cases are integrated with, analog or digital video recorders. A home may have one or more set-top boxes, typically deployed at each location where there is a television receiver. Homes with more than one television typically have a “main” viewing location where there is a larger television, and where additional equipment such as a digital video recorder (DVR), digital video disk player, video cassette player, and the like may also be found. Other television locations in the home may have a relatively smaller television and may not have the same level of peripheral equipment as the main viewing location. DVRs and DVR services, in particular, are somewhat expensive and are often located only in the main viewing location.

Televisions and computers in a home may be connected to receive the same signals from satellite or cable connections, but are typically not interconnected to share program data existing at only one location. For example, if a program is recorded on a conventional DVR at the main viewing location, there is no convenient way to transmit the program data to another location in the house where there is a video display driven by a set-top box or a computer, so as to replay the program at that other location.

Conventional set-top boxes do not provide a useful capacity for networking within the home, and provide virtually no functionality for interacting with other devices in the home. Some of the set-top boxes that have internal digital processors have been provided with a lower-speed digital data interface connector for other purposes. For example, a USB 1.1 interface that provides a 12 megabit per second data transfer capability has been provided in set-top boxes. This interface allows connection of a technician's computer to the set-top box for diagnostic purposes and to simplify loading software and firmware into the set-top box. Interfaces of this type do not offer sufficient bandwidth for streaming video and similar broadband networking functions. As far as the inventors are aware, interfaces of this type have not been used for local networking purposes, such as the transfer of broadband data between set-top boxes and/or computers.

Thus, there is a need for improved networking capacity and functionality in processing broadband data, particularly in the field of set-top boxes.

### BRIEF SUMMARY OF THE INVENTION

A video data processing device, such as a set-top box for satellite, DSL, or cable video and data services, has a high-speed interface to support connections to local devices and networks. The interface provides data connectivity with the internal system bus of the data processing device, to support wired and/or wireless home networking with computers and other set-top boxes, data storage and retrieval on hard drives and other storage media, and other data transfer operations to support digital cameras, game ports, and printers. In a preferred embodiment, the high speed interface is a standardized interface, such as a USB 2.0 interface, and is capable of streaming video data and other high-bandwidth data transfers to and from other local and networked devices.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a schematic diagram of a video data processing device according to one embodiment of the present invention.

FIG. 2 is a block schematic diagram of two video data processing devices connected using a high speed interface according to one embodiment of the invention.

FIG. 3 is a block schematic diagram illustrating a video data processing device and a personal computer connected according to an embodiment of the invention.

FIG. 4 is a block schematic diagram showing a video data processing device and a data drive connected according to an embodiment of the invention.

FIG. 5 is a block schematic diagram of a video data processing device and a digital camera connected according to an embodiment of the invention.

FIG. 6 is a block schematic diagram that shows a video data processing device and a printer connected according to an embodiment of the invention.

FIG. 7 is a block schematic diagram of a video data processing device and a game controller connected according to an embodiment of the invention.

FIG. 8 is a flow chart showing a device identification and connection process according to one embodiment of the invention.

FIG. 9 is a flow chart showing a video data streaming process according to one embodiment of the invention.

The present invention will now be described with reference to the accompanying drawings. In the drawings, some like reference numbers indicate identical or functionally similar elements. Additionally, the left-most digit(s) of most reference numbers identify the drawing in which the reference numbers first appear.

### DETAILED DESCRIPTION OF SELECTED EMBODIMENTS OF THE INVENTION

Embodiments of the present invention provide, among other things, a video data processing device with improved connectivity enabling data transfers between the video data processing device and one or more external devices.

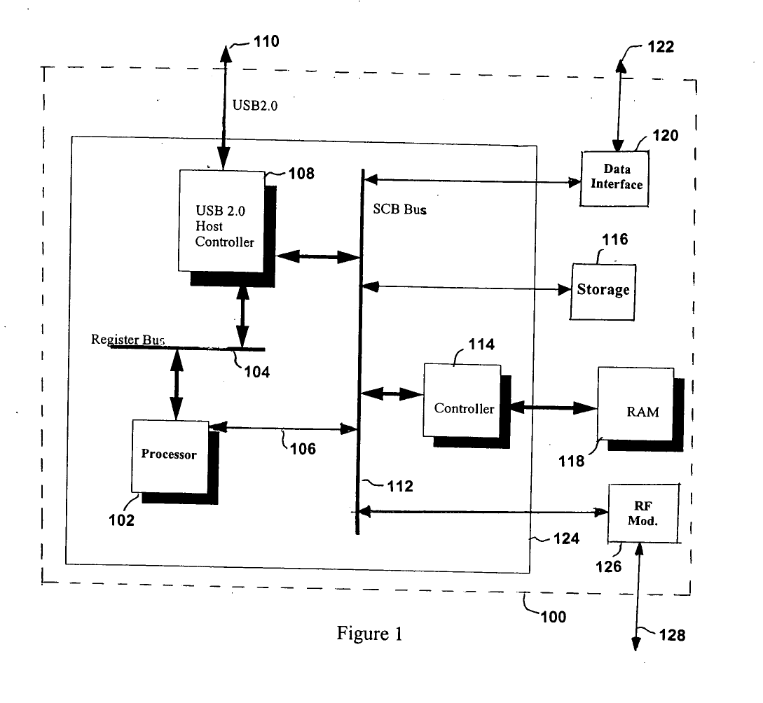

FIG. 1 is a partial block schematic diagram of a video data processing circuit according to an exemplary embodiment of the invention. In this embodiment, the video data processing circuit takes the form of a set-top box 100. Set-top box 100 comprises processor 102, register bus 104, bus connection 106, system control bus (SCB) 112, controller 114, memory 118, storage 116, data interface 120, port 122, Radio Frequency (RF) modulator 126, and port 128.

Set-top box 100 further comprises a high-speed digital data interface and a port associated with that interface. In the exemplary embodiment of FIG. 1, this high-speed data interface and port are represented by a USB 2.0 host controller 108 and USB 2.0 port 110. USB host controller 108 and port 110 provide a bi-directional digital data interface between set-top box 100 and external devices and/or networks. The USB 2.0 interface is capable of speeds up to 480 megabits per second. In general, for live video transmission, a transmission speed capability of at least approximately 110 megabits/second is desirable.

In operation, processor 102 executes stored instructions to control the operation of set-top box 100. Processor 102 may be any appropriate processor. As an example, processor 102 may comprise a processor core designed by MIPS Technologies, Inc. of Mountain View, Calif. Processor 102 may operate to provide desired operating features and interaction between set-top box 100 and external devices connected to host controller 108 using drivers appropriate to the connected devices.

Processor 102 is connected through register bus 104 to host controller 108. Both processor 102 and host controller 108 are also connected to system control bus 112. For example, register bus 104 may operate with a 27 MHz clock and SCB 112 may operate at an 81 MHz clock rate. The bus architecture of the system and the bus speed are merely exemplary, and the invention is not limited to any particular bus architecture or operating speed.

SCB 112 is connected through a data interface 120 to a port 122. Data interface 120 and port 122 are adapted to interface set-top box 100 with one or more broadband data sources. For example, port 122 may comprise a coaxial connector for connecting a cable television signal to set-top box 100. In other embodiments, port 122 may comprise appropriate connectors for interfacing telephone, wireless telephone, or satellite data sources to set-top box 100. Data interface 120 provides circuits and processing for transferring the data received at port 122 for use in set-top box 100.

RF modulator 126 generates a standard television signal, such as an NTSB, PAL, or SECAM signal, and provides the signal at an output port 128. Typically a computer, monitor, or television is connected to port 128 to display video programs received, processed, and/or stored by set-top box 100.

Controller 114 controls access to SCB 112 and provides an interface for memory device 118. In a preferred embodiment, controller 114 is a double data rate (DDR) controller and memory 118 is a 133 MHZ DDR SDRAM memory. Memory device 118 may be used as a buffer, as well as for data and variable storage and other operating memory requirements of set-top box 100. For example, memory device 118 may be used to store drivers for provided desired operating functions and interaction with external devices connected through host controller 108.

Storage device 116 is a mass-storage device used for storing and recording video data. For example, storage device 116 may be a hard drive or, in a preferred embodiment, is a digital video recorder (DVR) system such as a TIVO® system. Storage device 116 may be integrated into set-top box 100 or may be designed as a separate component with appropriate interface ports and cables connecting it to set-top box 100.

Set-top box 100 is preferably constructed with a high level of component integration to enhance reliability and reduce size and cost. Processor 102, host controller 108, controller 114, register bus 104 and SCB 112 are preferably integrated into a single chip device 124. Other components, including components of box 100, may also be integrated into single chip device 124 as desired.

In typical operation, set-top box 100 obtains program data through data interface 120, from storage 116, or from other external devices connected through one or more additional data interfaces (omitted for clarity). This program data is then processed through RF modulator 126 and transmitted for display through port 128. In a preferred embodiment of the present invention, further functionality is provided through the provision and novel operation of host controller 108 and port 110. In particular, port 110 may be connected to a variety of external devices, either directly or using networking components and transmission channels. Host controller 108 may then be used to exchange video data with the external device or devices, acting as a transmitter, a receiver, or both.

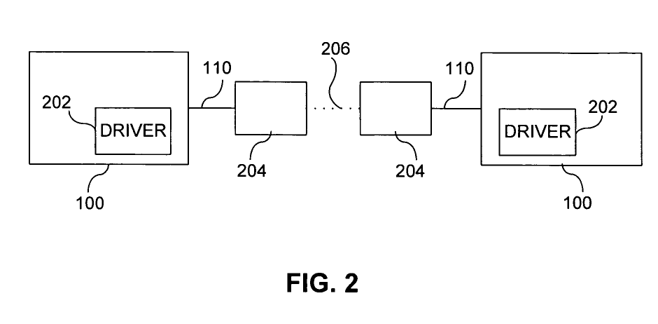

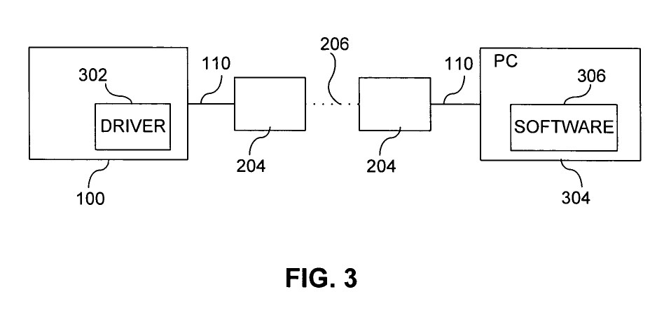

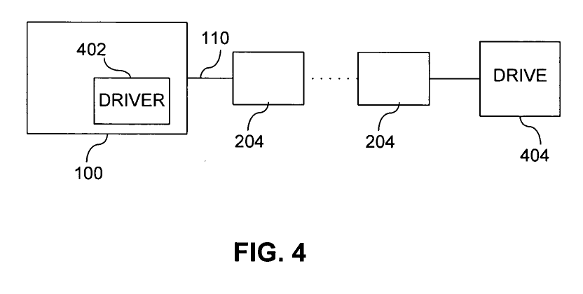

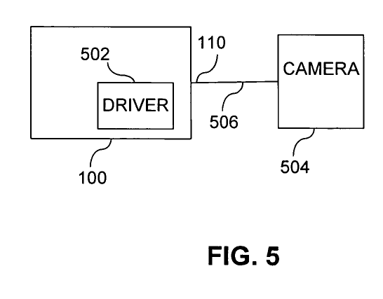

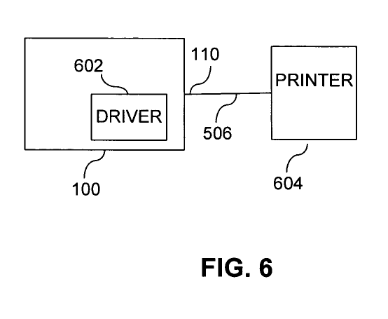

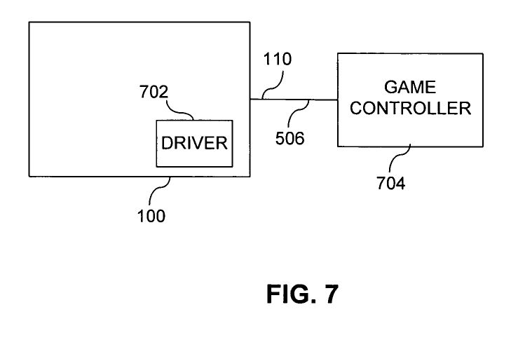

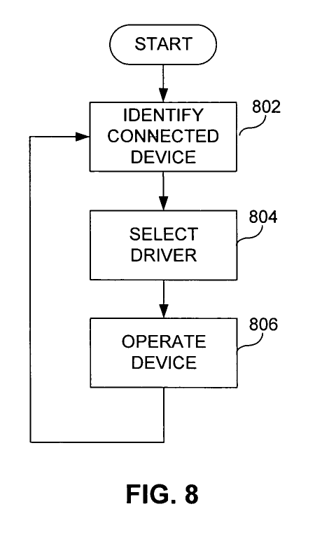

Examples of external devices that can be connected to host controller 108 for operating in conjunction with set-top box 100 include: another set-top box (FIG. 2), a personal computer (FIG. 3), a mass storage device (FIG. 4), a camera (FIG. 5), a printer (FIG. 6), and a game controller (FIG. 7). Of course, the scope of the invention is not limited to these exemplary devices. Other devices may be connected to host controller 108 for operation with set-top box 100. These devices and others may have associated drivers that operate in set-top box 100 to provide desired functionality in the operation of set-top box 100 and the connected devices. The drivers may implement any desired functions, and are not limited to the functions described with reference to the exemplary embodiments. Preferably, a plurality of drivers are available for compatibility with different devices, and the appropriate driver is selected for operation according to the process shown in FIG. 8.

FIG. 2 shows two set-top boxes 100 connected by ports 110 according to one embodiment of the invention. As described above, ports 110 provide each set-top box with an external interface for a high-speed connection, such as a USB 2.0 connection. In the illustrated embodiment, port 110 of each set-top box 100 is connected to a communications channel interface device 204, which provides an interface to a communications channel 206 between the two interface devices 204.

Interface device 204 may be any appropriate interface device for connecting port 110 to communications channel 206. For example, interface devices 204 may be Ethernet ports. In one preferred embodiment, interface devices 204 are interfaces to an IEEE 802.11-compliant wireless network. The use of a local wireless network allows set-top boxes at a single location to easily share program data, without installing additional wiring, in a manner that will be described in more detail below.

In another embodiment, the functions of interface devices 204 and communications channel 206 are provided by a USB cable connected between the two ports 110. A cable connection of this type may be operated with or without an amplifying device depending on distance.

Communications channel 206 may be any communications channel, including those employing wireless and/or wired channels. Communications channel 206 may be a local channel or a wide area network channel, may include other networks such as the internet or a private network, and may employ other devices and structures as desired. It will be understood that in the preferred embodiments, port 110 operates using a standardized interface, and therefore the invention does not rely on the use of any particular connection architecture or protocols between the interface devices 204. Such architectures and protocols will be transparent to the set-top boxes 100 and their drivers and interfaces, as long as they provide the requisite throughput and connectivity to support the data transfer functions being performed by set-top boxes 100.

Each set-top box 100 is provided with a driver 202. Driver 202 is a program, embodied in hardware, firmware, or software, and operating in one or more processors in set-top box 100, that controls the operation of desired functions for data transfer between the two set-top boxes 100.

In a preferred embodiment, driver 202 provides a function of selectively transmitting program data from a selected source available to set-top box 100 to the other set-top box 100, through port 110 and communications channel 206. In this embodiment, driver 202 also provides the function of receiving such program data from another set-top box 100 and storing and/or displaying the program data. With these two functions implemented, it is possible to display program content that would normally be available only at a first location (for example, in a digital video recorder in the set-top box 100 on the left) at a second location remote from the first location (such as the set-top box 100 located on the right).

Drivers 202 preferably support on-screen feature selection, including for example allowing the user to select programs for transmission, select one or more programs to be received from a menu of programs available through a remotely connected set-top box, and control program transmission and/or display such as with start, stop, pause, fast forward, and reverse features. As another option, drivers 202 may implement remote control of a digital video recorder associated with one of the set-top boxes 100, whereby a user at one set-top box can request recording and/or replay of a program by a digital video recorder associated with another set-top box 100. To implement these various features, driver 202 may receive a control input from a user and transmit data representing that control input to the remote set-top box. Driver 202 in the remote set-top box may then receive the data representing the control input and perform the desired function.

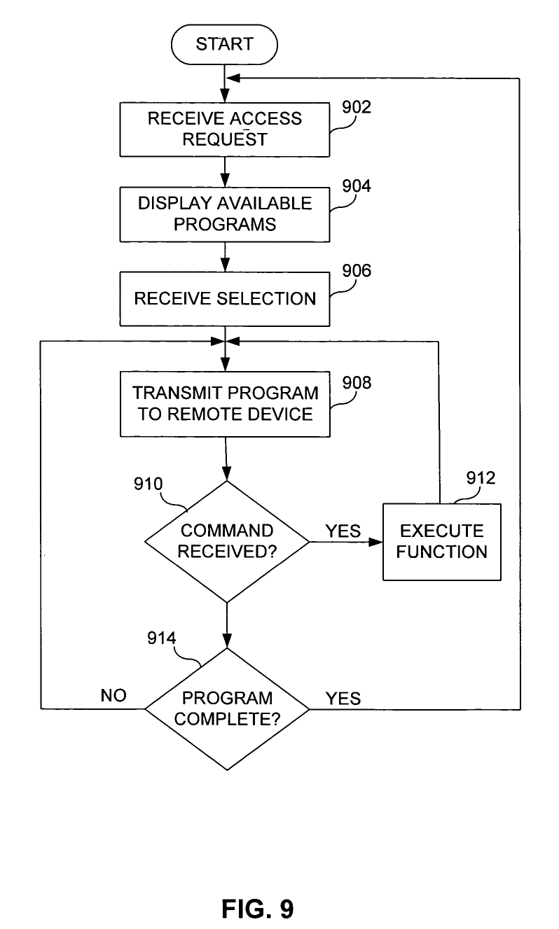

A preferred embodiment of a process for performing some of the driver functions described herein is shown in FIG. 9, and described in further detail below with reference to FIG. 9.

FIG. 3 shows a set-top box 100 connected by a port 110 to a personal computer 304 through interface devices 204 and communications channel 206. The features and operation of interface devices 204 and communications channel 206 are similar to those described with reference to FIG. 2.

In one embodiment, set-top box 100 has a driver 302 and personal computer 304 has driver 306. Driver 302 performs a function of selectively transmitting program data from any of the sources available to set-top box 100 to personal computer 304, through port 110 and communications channel 206. Driver 306 provides the function of receiving such program data from set-top box 100 and storing and/or displaying the program data using the resources of personal computer 304. With these two functions implemented, it is possible to display program content that would normally be available only at the set-top box 100 at the location of personal computer 304.

In another embodiment, drivers 302 and 306 provide for transmission of program information from personal computer 304 to set-top box 100 for storage and/or display. In this way, mass storage devices (for example, digital video disk players) and broadband network connections associated with personal computer 304 can be used as sources of program content to be displayed by set-top box 100 on an associated television or monitor. Drivers 302 and 306 may optionally support video editing using software operating in personal computer 304.

Drivers 302 and 306 preferably support on-screen feature selection, including for example allowing the user at one of the devices to select programs for transmission to the other device. Further, a user of set-top box 100 may preferably select one or more programs to be received from a menu of programs available through personal computer 304, and a user of personal computer 304 may preferably select one or more programs to be received from a menu of programs available through set-top box 100. Finally, in a preferred embodiment, a user at either location is able to control program transmission and/or display such as with start, stop, pause, fast forward, and reverse features.

As another option, either or both of drivers 302 and 306 may implement remote control of a digital video recorder associated with set-top box 100 or a storage device associated with personal computer 304, whereby a user at one unit can request recording and/or replay of a program stored by the other unit. To implement these various features, drivers 302 and 306 may receive a control input from a user and transmit data representing that control input to the other device. The driver in the remote device may then receive the data representing the control input and perform the desired function.

A preferred embodiment of a process for performing some of the functions of drivers 302 and 306 as described herein is shown in FIG. 9, and described in further detail below with reference to FIG. 9.

FIG. 4 shows the connection of a set-top box 100 by port 110 to a mass storage device 404 through interface devices 204 and communications channel 206. The features and operation of interface devices 204 and communications channel 206 are similar to those already described with reference to FIG. 2. Mass storage device 404 may be any desired mass storage device and may have reading and/or writing capability. For example, mass storage device 404 may be a USB read/write drive, a DVD drive, a hard disk drive, or any other mass storage technology known or to be developed in the future. Preferably mass storage device 404 has an interface compatible with the interface protocol of port 110 of set-top box 100, for example, a USB 2.0 interface. Various USB drives are known and typically provide a standardized interface for creating and deleting “files” and for storing and reading data in those files.

In this embodiment, set-top box 100 has a driver 402. Driver 402 performs a function of selectively transmitting and/or receiving program data between mass storage device 404 and any of the sources and outputs available to set-top box 100. Driver 402 performs this function by controlling transmission and reception of program data through interfaces 204 and communications channel 206. With this functionality implemented, it is possible to store program content that would normally be available only at the set-top box 100 using mass storage device 404 if mass storage device 404 is a read/write device. It is also possible to read program content from mass storage device 404 and then either store or display the program content using set-top box 100.

Driver 402 preferably provides a file interface, such as a standard USB drive interface used in Microsoft Windows™ based personal computers, to allow storage and/or subsequent selection, retrieval and display of program content using mass storage device 404. Preferably, driver 402 provides an on-screen menu control interface whereby the programs available on mass storage device 404 can be displayed to allow the user to select a desired program for viewing.

Optionally, driver 402 may also implement features such as control of data flow and program display in response to user input. For example, start, stop, pause, fast forward, reverse, and track or chapter seeking features may be provided to facilitate the user's retrieval and review of specific program material. To implement these features, driver 402 may receive a control input from a user and transmit data representing that control input to the interface of port 110, or to drive 404, as appropriate.

FIG. 5 shows an embodiment of the invention wherein a camera 504 with a digital interface is connected via a connection 506 to port 110 of set-top box 100. Connection 506 may be a standardized cable connection, such as a USB cable, or may be any wired or wireless connection such as the interfaces 204 and communications channel 206 shown in FIG. 2 and described previously with reference to FIG. 2.

Driver 502 provides a data transmission control interface between set-top box 100 and camera 504. Driver 502, may, if desired, allow set-top box 100 to retrieve data from camera 504 for display and/or storage. For example, the retrieved data may take the form of still frame pictures or video data. The data retrieved from camera 504 may be stored in set-top box 100 or associated devices, or may be displayed on a monitor or television for viewing. Driver 502 may also optionally provide controls that selectively cause transmission of video and/or still frame data from set-top box 100 to camera 504 to be stored and/or recorded in camera 504. For example, driver 502 may, in response to a user input, control set-top box 100 so that it operates as a frame grabber to transmit image data from a current video frame to camera 504. In this manner, a “snapshot” of a currently displayed image can be stored in camera 504. If camera 504 is a video camera, driver 502 may control set-top box 100 to transmit streaming video data to camera 504.

FIG. 6 shows an embodiment of the invention wherein a printer 604 with a digital interface is connected via a connection 506 to port 110 of set-top box 100. Connection 506 may be a standardized cable connection, such as a USB printer cable, or may incorporate any wired or wireless connection such as the interfaces 204 and communications channel 206 shown in FIG. 2 and described previously with reference to FIG. 2.

Driver 602 provides a data transmission control interface between set-top box 100 and printer 604. Driver 502 preferably provides controls that selectively cause transmission of video image data from set-top box 100 to printer 604 to be printed. Driver 602 is preferably designed to operate with printer 604 to correctly format the data transmission for optimal reproduction of the video image data on printer 604. As an operational example, driver 602 may, in response to a user input, control set-top box 100 so that it operates as a frame grabber to transmit image data from a current video frame to printer 604. In this manner, a “snapshot” of a currently displayed image can be printed using printer 604. This feature can be used in conjunction with pause and frame advance features of a set-top box 100 incorporating a digital video recorder or the like, so that a desired image from a video program can be located and printed.

FIG. 7 shows an embodiment of the invention wherein a game controller 704 with a digital interface is connected via a connection 506 to port 110 of set-top box 100. Connection 506 may be a standardized cable connection, such as a USB cable, or may be any wired or wireless connection such as the interfaces 204 and communications channel 206 shown in FIG. 2 and described previously with reference to FIG. 2.

Driver 702 provides a data transmission control interface between set-top box 100 and game controller 704.

In a first embodiment, game controller 704 is a user input device for controlling operation of a video game. In this embodiment, set-top box 100 is provided with internal processing capacity for operating and displaying video-based games, and a control input for such games operating within set-top box 100 is attached to port 110. Driver 702 receives user input from game controller 704 and provides data representing the received inputs to the processor in set-top box 100, whereby the game operates in accordance with the user input at game controller 704.

In a second embodiment, game controller 704 may be a video game system, such as a Sega®, Nintendo®, X-Box® or other video game. In this embodiment, driver 702 allows game controller 704 to transmit video data for display and/or recording and playback using the functionality of set-top box 100.

FIG. 8 is a flow chart showing a process according to one embodiment of the invention for selectively operating any of a plurality of devices using a high-speed data interface of a set-top box. The high speed data interface is preferably provided as described above with reference to FIG. 1. In this embodiment, the process operates as follows.

In step 802, the device connected to the interface is identified.

Identification may be manual, such as by user input, or automatic, such as by a handshaking protocol with the connected device whereby the device identifies itself. The connected device may be any device, including for example another set-top box (embodiment of FIG. 2), a personal computer (embodiment of FIG. 3), a mass storage device (embodiment of FIG. 4), a camera (embodiment of FIG. 5), a printer (embodiment of FIG. 6), and/or a game controller (FIG. 7).

Following identification, control passes to step 804 and the appropriate driver for the connected device is selected from among the available drivers in set-top box 100. If no appropriate driver is internally available, set-top box 100 may prompt the user to provide a driver or may attempt to automatically obtain an appropriate driver via a connected data source such as a mass storage device, a personal computer, or the Internet.

The selected driver will preferably provide interface and control functionality appropriate to the device, such as one or more of the functions described previously with respect to the exemplary devices. Then, in step 806, the interface is operated with the selected driver to interact effectively with the connected device.

FIG. 9 is a flow chart showing a process according to another embodiment of the invention wherein program data available at a set-top box is transmitted to a remote device for viewing at that location in response to a user request from the remote device location. The remote device may be, for example, another set-top box as shown in FIG. 2 and described above with reference to that figure, or a personal computer as shown in FIG. 3 and described above with reference thereto.

The process of FIG. 9 begins with step 902, where an access request is received from a remote device. For example, an access request may be received from another set-top box or a personal computer connected to the set-top box through a USB 2.0 interface or the like. In step 904, a menu of available video programs may optionally be transmitted to the remote device for display so that the user can select from among the available programs, such as by on-screen interactive selection at the remote device location. In step 906, the user selection is received by the set-top box. The user selects a program and the selection is either directly input into the system, or transmitted from the user location (to the extent the user is near the remote unit or otherwise not at the local set-top box).

In step 908, data for the selected program is retrieved from the source (whether live broadband input, digital video recorder, or other available source) and transmission to the remote device begins. During transmission, the system monitors the connection with the remote device for commands. In step 910, if a command has been received, control passes to step 912 and the commanded function is executed. For example, a command to pause, stop, fast forward, review, rewind, skip commercials, or jump to a particular chapter or section of the program may be received. The functions required by such commands are then executed in step 912 and control passes to step 908, where transmission continues as appropriate.

If no new command is received, in step 914, the system determines whether transmission of the program is complete. If the program is complete (either it has reached the end or the user has provided a stop or end command), the process of FIG. 9 is also complete and can be restarted at step 902 if desired. If in step 914 the program is not complete, the process continues at step 908 with further transmission of the program according to the last command received.

This process has been described in terms of the operation of the set-top box transmitting a program to another device. However, those skilled in the art will understand that the remote device operates using a program implementing functions that correspond to those just described. That is, the remote device will transmit an access request, receive available program data (if implemented) and display that data, transmit a user selection if desired, receive the program data for display, and transmit commands as appropriate. All of these “receiving device” functions correspond logically to the “transmitting device” functions shown in FIG. 9.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A set-top box device for processing video data, comprising:
one or more video data sources including at least an external broadband video data source;
a video signal output;
a processor circuit;
a standardized digital interface connected to the processor circuit, said digital interface having a transmission speed sufficient to support streaming a digitized standard television video signal to an external device; and
a stored program comprising instructions that initiate transmission of data received from at least one of said data sources to said external device using said standardized digital interface.

2. The device of claim 1, wherein said video data sources include a satellite television receiver.

3. The device of claim 1, wherein said video data sources include a cable television receiver.

4. The device of claim 1, wherein said video data sources include a digital telephone data receiver.

5. The device of claim 1, wherein said standardized digital interface is a Universal Serial Bus interface version 2.0 or greater.

6. The device of claim 1, wherein said standardized digital interface has a nominal transmission speed of at least approximately 110 megabits/second.

7. The device of claim 1, wherein said data sources include a digital video recorder and video data from said digital video recorder is transmitted to said external device using said standardized digital interface.

8. The device of claim 1, wherein said external device comprises a second set-top box.

9. The device of claim 1, wherein said stored program further comprises instructions that actuate said device to receive video data from a second set-top box using said standardized digital interface.

10. The device of claim 9, wherein said stored program further controls said device to provide a video signal at said video signal output corresponding to said video data received from said second set-top box.

11. The device of claim 1, wherein said external device comprises a personal computer.

12. The device of claim 1, wherein said stored program further comprises instructions that actuate said device to receive video data from a personal computer using said standardized digital interface.

13. The device of claim 12, wherein said stored program further comprises instructions that actuate said device to provide a video signal at said video signal output corresponding to said video data received from said personal computer.

14. The device of claim 1, wherein said external device comprises a mass storage device.

15. The device of claim 14, wherein said mass storage device comprises a digital video disk drive.

16. The device of claim 14, wherein said mass storage device comprises a USB drive.

17. The device of claim 1, wherein said stored program further comprises instructions that actuate said device to transmit video data to a mass storage device using said standardized digital interface.

18. The device of claim 1, wherein said stored program further comprises instructions that actuate said device to receive video data from a mass storage device using said standardized digital interface.

19. The device of claim 18, wherein said stored program further comprises instructions that actuate said device to provide a video signal at said video signal output corresponding to said video data received from said mass storage device.

20. The device of claim 1, wherein said external device comprises a camera.

21. The device of claim 1, wherein said external device comprises a printer.

22. The device of claim 1, wherein said external device comprises a game controller.

23. A set-top box system for processing video data, comprising:
one or more video data sources, and
a set-top box including:
a processor circuit;
a video output;
at least one video input connected to one or more of said video data sources;
a Universal Serial Bus (USB) interface, connected to the processor circuit, said USB interface having at least USB 2.0 speed; and
a stored program that operates in said processor circuit to actuate transmission of digitized video data between said external device and said processor circuit, using said USB interface.

24. The system of claim 23, wherein said video data sources include a satellite television receiver circuit.

25. The system of claim 23, wherein said video data sources include a cable television receiver circuit.

26. The system of claim 23, wherein said video data sources include a digital telephone data receiver circuit.

27. The system of claim 23, wherein said data sources include a digital video recorder and video data from said digital video recorder is transmitted to said external device using said USB interface.

29. The system of claim 23, wherein said external device comprises a second set-top box.

30. The system of claim 23, wherein said stored program further comprises instructions that actuate said set-top box to receive video data from a second set-top box using said USB interface.

31. The system of claim 30, wherein said stored program further comprises instructions that actuate said set-top box to provide a video signal at said video output corresponding to said video data received from said second set-top box.

32. The system of claim 30, wherein said stored program further comprises instructions that initiate an access request to obtain information regarding available programs from said second set-top box.

33. The system of claim 32, wherein said stored program further comprises instructions that receive and display information regarding programs available from said second set-top box.

34. The system of claim 30, wherein said stored program further comprises instructions that transmit user commands to said second set-top box for controlling transmission of the program from said second set-top box.

35. The system of claim 23, wherein said external device comprises a personal computer.

36. The system of claim 23, wherein said stored program further comprises instructions that actuate said set-top box to receive video data from a personal computer using said USB interface.

37. The system of claim 36, wherein said stored program further comprise instructions that actuate said set-top box to provide a video signal at said video output corresponding to said video data received from said personal computer.

38. The system of claim 23, wherein said external device comprises a mass storage device.

39. The system of claim 38, wherein said mass storage device comprises a digital video disk drive.

40. The system of claim 38, wherein said mass storage device comprises a USB drive.

41. The system of claim 23, wherein said stored program further comprises instructions that actuate said set-top box to transmit video data to a mass storage device using said USB interface.

42. The system of claim 23, wherein said stored program further comprises instructions that actuate said set-top box to receive video data from a mass storage device using said USB interface.

43. The system of claim 42, wherein said stored program further comprises instructions that actuate said set-top box to provide a video signal at said video output corresponding to said video data received from said mass storage device.

44. The system of claim 23, wherein said external device comprises a camera.

45. The system of claim 23, wherein said external device comprises a printer.

46. The system of claim 45, wherein said set-top box further comprises a control interface circuit connected to the processing circuit, said control interface circuit receiving user input indicating that a printing operation is desired, wherein the processing circuit transmits digital data to said printer corresponding to a current video output display in response to said user input.

47. The system of claim 23, wherein said external device comprises a game controller.

48. The system of claim 23, further comprising a plurality of said stored programs, and means for selecting and actuating one of said stored programs corresponding to said external device in use.

49. The system of claim 48, further comprising a program operating in the processing circuit that automatically detects the external device in use and selects a corresponding stored program.
